(19) United States
(12) Patent Application Publication
(10) Pub. No.: US 2001/0052019 A1
(43) Pub. Date: Dec. 13, 2001

(54) Video mail delivery system

(75) Inventors: Robert J. Walters, Duluth, GA (US); Richard E. Bennett JR., Buford, GA (US)

Correspondence Address: WOMBLE CARLYLE SANDRIDGE & RICE, P.O. Box 725388, Atlanta, GA, 31139-9388, US

(73) Assignee: OVT, Inc.

(21) Appl. No.: 09/777,216

(22) Filed: Feb. 5, 2001

Related U.S. Application Data
(60) Provisional application No. 60/180,283, filed on Feb. 4, 2000.

(51) Int. Cl. G06F 15/16

(52) U.S. Cl. 709/231; 709/219; 709/206

(57) ABSTRACT

A video mail delivery system for generating and transmitting video mail between a sender computer and a receiver computer over a communications network, such as the Internet. A video mail file containing audio and video content is recorded in a standard audio video interleave format and is then reformatted and compressed into an advanced streaming format. A video mail message window on the sender computer display enables the addition of an electronic text message to the video mail. A hyperlink to the compressed video mail file is inserted automatically into the video mail message window. When the video mail message is sent, the compressed video mail file is transmitted to a video store and forward server that stores the video mail file until it is accessed by the destination receiver computer. The electronic text message and hyperlink to the video mail file are sent to the electronic mail server of an Internet services provider for delivery to the mail server of the receiver computer's Internet services provider. When the electronic text message is opened, the user at the receiver computer clicks on the hyperlink to have the selected video file streamed from the video server to the receiver computer, where it is viewed in a video mail window display.

### CROSS-REFERENCE TO RELATED APPLICATION

The present invention is a formalization of a previously filed, co-pending U.S. Provisional Patent Application entitled “Video Mail Delivery System”, filed Feb. 4, 2000 as Ser. No. 60/180,283 by the inventors named in this patent application. This patent application claims the benefit of the filing date of the cited Provisional Patent Application, according to the statutes and rules governing provisional patent applications, particularly 35 U.S.C §119(e)(1) and 37 C.F.R. §1.78(a)(3) and (a)(4). The specification and drawings of the Provisional Patent Application are specifically incorporated by reference herein.

### BACKGROUND OF THE INVENTION

The present invention relates to an electronic mail system, and more particularly, to a video mail system providing for the delivery of multimedia content as an attachment to electronic mail.

The most common format for audio and video data on a personal computer (PC) is the Audio Video Interleave (AVI) format. AVI is a de facto standard defined by Microsoft Corporation and is a special case of the Resource Interchange File Format (RIFF).

A major limitation of video on the World Wide Web in general, and of AVI in particular, is the limited bandwidth available. Currently, most users with telephone service have a 28.8 kilobits per second (Kbps) or 33.6 Kbps connection to their Internet Service Provider (ISP). The new generation of modems may eventually provide 50-60 Kbps over traditional analog telephone lines. A Basic Rate Interface (BRI) Integrated Services Digital Network (ISDN) connection provides 128 Kbps.

Although very high speeds are possible within the Local Area Networks (LANs) and Wide Area Networks (WANs) of major corporations and other organizations, the so-called Intranet, the actual rates achieved over the World Wide Internet are generally much less. These Internet rates provide very low bit rates for video. The prevailing block Discrete Cosine Transform (DCT) based video codecs (compressors/decompressors) such as MPEG-1, H.261 and H.263 perform acceptably at 384 Kbps, but frequently exhibit unnatural artifacts at 128 Kbps for 30 frame per second 320×240 pixel video.

Ultimately, the faster Internet connections and better codecs will combine to resolve this problem and allow convincing, realistic video over the Internet. In the meantime, however, web authors planning to use video must provide highly compressed video at low bit rates. The options include using smaller frame sizes, using lower frame rates (10-15 frames per second), pushing the standard codecs as far as possible and using one of the newer codecs.

AVI was developed for playback of audio and video from hard disks and CD-ROMs on personal computers. AVI files are also adequate for downloading from a remote site on the Internet for subsequent playback from the computer's hard drive. They are not well suited for real-time or streaming video playback over networks. The AVI file format lacks timestamps embedded in the audio and video streams. There is no mechanism to resynchronize the audio and video streams if data is lost. In a network, sometimes packets are lost in which the audio and video playback will lose track of the time. With timestamps, the application can resynchronize the audio and video playback. Users can store AVI files with uncompressed frames. No codec is required for this. The video data in an AVI file can be formatted and compressed in a variety of ways.

Microsoft Corporation has a new generation of products in the form of Advanced Streaming Format (ASF) with improved support for video over networks. Microsoft Corporation also provides utilities for converting AVI files to the new ASF format.

MPEG (Moving Picture Experts Group) is an International Electrotechnical Commission/International Organization for Standardization (ISO/IEC) working group developing international standards for compression, decompression, and representation of moving pictures and audio. MPEG-4 is a recent standard from ISO/IEC for the coding of natural and synthetic audiovisual data in the form of audiovisual objects that are arranged into an audiovisual scene by means of a scene description. MPEG-4 is a new standard for streaming digital information. Not only does it compress video information well, it is designed to be streamed, i.e., it can be played as it appears on a hard drive, unlike most video formats which require that all frames be downloaded. MPEG works by only encoding visual information that the eye can detect and only changes between frames. This information is further compressed in a typical manner and then the bit stream is encoded so that it can be read and decoded a few frames at a time. Decoders rely on an algorithm that uses previous frames and upcoming frames to encode the current frame.

Currently, to encode and decode MPEG requires a lot of computer processor intensive work. Furthermore, most low level encoders do not support the synchronization of audio and video. MPEG audio is an entirely different matter and is not part of the video standard. Some decoders do support audio. Typically, MPEG requires expensive encoding suites and specific hardware. Conversion typically consists of encoding from a high quality AVI video.

Compression ratio is the size of the original video to the size of the compressed video. To get better compression ratios, pixels are predicted based on other pixels. The spatial prediction of a pixel can be obtained from pixels of the same image; in temporal predictions, the prediction of a pixel is obtained from a previously transmitted image. Motion compensation establishes a correspondence between elements of nearby images in the video sequence.

File size barriers, intentionally imposed by ISPs prevent transmission of large multimedia files as attachments to traditional electronic mail. Typically, one minute of a multimedia file equates to about 100 megabytes; the limit imposed by ISPs is typically less than two megabytes. In addition, large multimedia files, typically “.avi” files, require long connection times for high quality multimedia files to be transmitted from a sender to an addressee. Furthermore, space restrictions on ISP electronic mail servers will not accommodate storage of large multimedia files.

### SUMMARY OF THE INVENTION

The present invention provides a system that permits delivery of large quantities of multimedia data without interfering with the data transmissions associated with electronic mail delivery. The mechanisms of the present invention are applicable to existing computer network systems, such as the Internet, intranets, wide area networks and virtual private networks. A video-streaming server facilitates the delivery of multimedia content (i.e., video and audio) from a sender computer to a receiver computer. As used herein, client device refers to the communications endpoint devices of any type, either wired or wireless, including, but not limited to, desktop computers, laptop computers, computer workstations, network computers, personal digital assistants and wireless handheld devices. A server device refers to any computing system that interacts with a client device over a communications network using a client-server architecture.

The present invention is implemented through the use of an application software program installed on the sender computer and a video-streaming server. The application software program resident on a client sender computer system opens up a video interface window in a Visual Basic Application. This application has a mapping interface to all the standard electronic mail interfaces in a PC type product. Upon opening of the application, a connection is created from the application to the video and audio microphones and video camera sources located on a PC device. The application provides operator controls for the starting and stopping of the recording of the session. When an operator chooses to record a video mail message, a record button is clicked on. When the record button on the user interface display is initialized, a temporary file is created on a local hard drive of the PC in a standard multimedia format, i.e., an “.avi” format video file. The recording continues until stopped by the sender operator. At this point in time, the video file is stopped also; the recording is stopped and the operator can replay the file via the user interface to preview it and he also has controls as part of the sender-user interface that controls the volume of the playback. The operator can stop and start as well as delete the audiovisual file. When the originator is satisfied with the quality of the presentation, the originator uses the application to send a video electronic mail. At this point, two parallel paths are followed by the electronic mail and the video attachment. The attached video “.avi” file, which was created in a temporary folder, goes through a process of reformatting and compression (for example, MPEG-4 compression). The output of this file is a “.asf” or “.asx”, which are standard Microsoft Corporation file formats. The AVI file is then stored on the local hard drive of the sender computer for later preview by the operator. The electronic mail message itself is sent through the standard electronic mail interface provided by an Internet Service Provider (ISP). In place of the video content window that exists at the sender user interface, an icon is created in the electronic mail with a link to a specific file name. The file name for the video window is also created by the client application on the sender computer. When the file is sent, the traditional electronic mail content is sent through the standard ISP with no video attachment, just an Uniform Resource Locator (URL) link. In parallel, the “.asf” or “.asx” file will be sent through the client application in a video-streaming video which is stored on a video-streaming server. Upon receipt of the file, the video server verifies the integrity of the file and that it is free of any virus contamination. It also verifies the authenticity of the file and that the originator is an authorized user of the system. The video file is stored on the video server for a predetermined period of time. The file is retained on the video server until it is deleted.

Upon receipt of an electronic mail message, the recipient will have an URL link in the form of an icon in the electronic mail message that was created by the client software at the sender computer. When the recipient clicks on the icon included in the received electronic message, a request will go out through an Internet Service Provider or institutional service provider that is represented as a link from the recipient back to the video-streaming server. Clicking on the icon at the receiver computer causes the video stored on the video-streaming server to be played back through the standard electronic mail interface at the recipient computer. The video is played back through a standard Microsoft application or any other standard applications such as Real-Time players because the video file format is compatible with all the standard applications.

### BRIEF DESCRIPTION OF THE DRAWINGS

The invention is better understood by reading the following detailed description of the invention in connection with the accompanying drawings, wherein:

FIG. 1 illustrates an overview of the video mail delivery system in accordance with an exemplary embodiment of the present invention.

FIG. 2 illustrates the video electronic mail user interface provided by client software installed at the sender computer in accordance with an exemplary embodiment of the present invention.

FIG. 3 illustrates a standard electronic mail interface of a recipient in accordance with an exemplary embodiment of the present invention.

FIGS. 4A-4B illustrate the processing logic associated with the video mail delivery system in accordance with an exemplary embodiment of the present invention.

FIG. 5 illustrates the software functions performed by components of the video mail delivery system in accordance with an exemplary embodiment of the present invention.

### DETAILED DESCRIPTION OF THE INVENTION

The following detailed description of the present invention is provided as a detailed, enabling teaching of the present invention in the context of an exemplary embodiment. Those skilled in the relevant arts will recognize that many changes can be made to the embodiment described while still obtaining the beneficial results of the present invention. It will also be apparent as some of the desired benefits of the present invention can be obtained by selecting some of the features of the present invention without using other features. Accordingly, those who work in the art will realize that many modifications and adaptations to the present invention are possible and may even be desirable in certain circumstances and are a part of the present invention. Thus, the following description is provided as illustrative of the principles of the present invention and not in limitation thereof, since the scope of the present patent is defined by the claims.

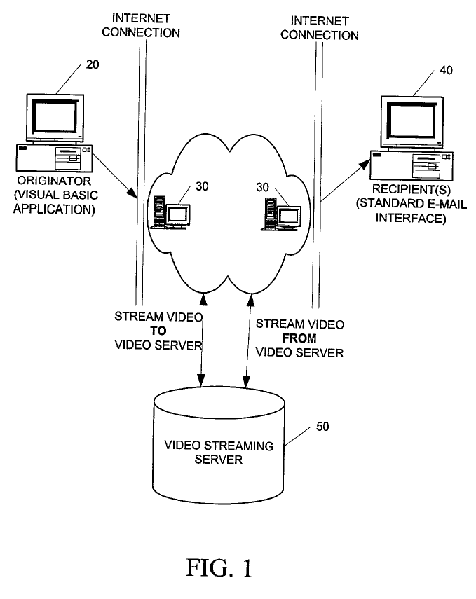

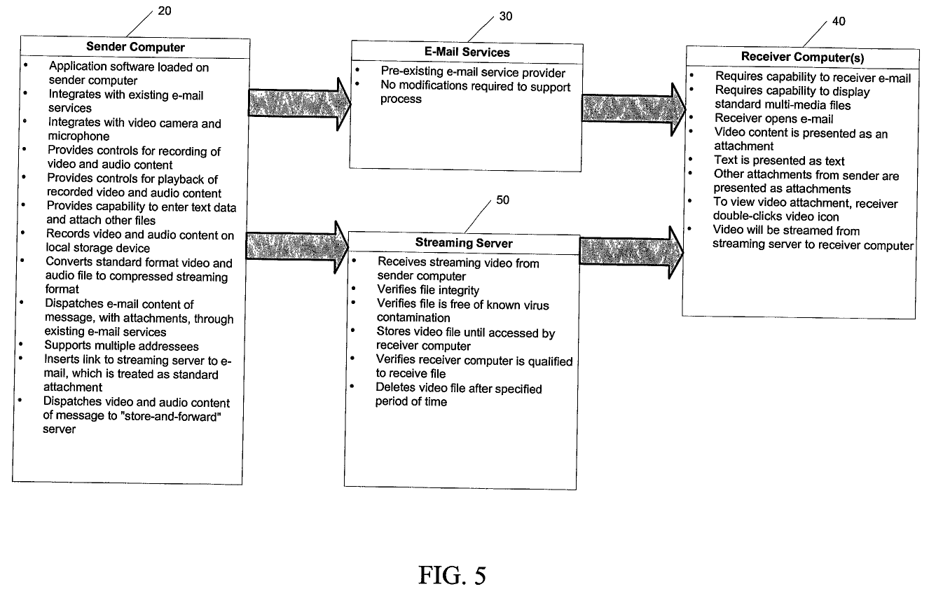

FIG. 1 illustrates communication between a sender computer 20 and a receiver computer 40 using standard electronic mail services provided by an Internet Service Provider (ISP) 30. Also shown in FIG. 1 is a video-streaming server 50 which enables the transmission of multimedia content between sender computer 20 and receiver computer 40. FIG. 5 illustrates the software functions performed by components depicted in FIG. 1, and both should be referred to fully understand the mechanisms of the invention.

Special client application software is loaded on sender computer 20 to enable use of the video-streaming server 50 of the present invention. The application software integrates with existing electronic mail services, integrates with a video camera and microphone, and provides for recording and playback of video and audio content. The client application software installed on sender computer 20 also converts standard format video and audio files to a compressed streaming format. The electronic mail content of a message with attachments is transmitted through the existing electronic mail services provided by the ISP. The client application software inserts a link to the video-streaming server 50 in the electronic mail message that is transmitted through the standard electronic mail services. It further sends the video and audio content of the message to the video-streaming server 50, which is a “store-and-forward” server.

The receiver computer 40 is required to have the capability to receive electronic mail messages and to display standard multimedia files. The video file is streamed in the form of packets (generally as User Datagram Protocol or UDP packets) to the receiver computer 40, where they are placed into a buffer. Once the receiver computer 40 opens an electronic mail message, the video content is presented as an attachment in the form of an icon. The electronic mail text is presented as ordinary ASCII text. To view a video attachment, the receiver clicks on a video icon in the electronic mail message. The video content is then streamed from the video-streaming server 50 to the receiver computer 40. In order to display the video file, the receiver computer 40 launches a video player and sends the contents of the buffer to the video player.

The video-streaming server 50 receives streaming video from a sender computer 20. The video-streaming server 50 then verifies the video file integrity, and verifies that the video file is free of known virus contamination. Video-streaming server 50 then stores the video file until accessed by receiver computer 40. The video-streaming server 50 also verifies that the receiver computer is qualified to receive the video file. After a predetermined period of time, the video file is automatically deleted from the video-streaming server 50.

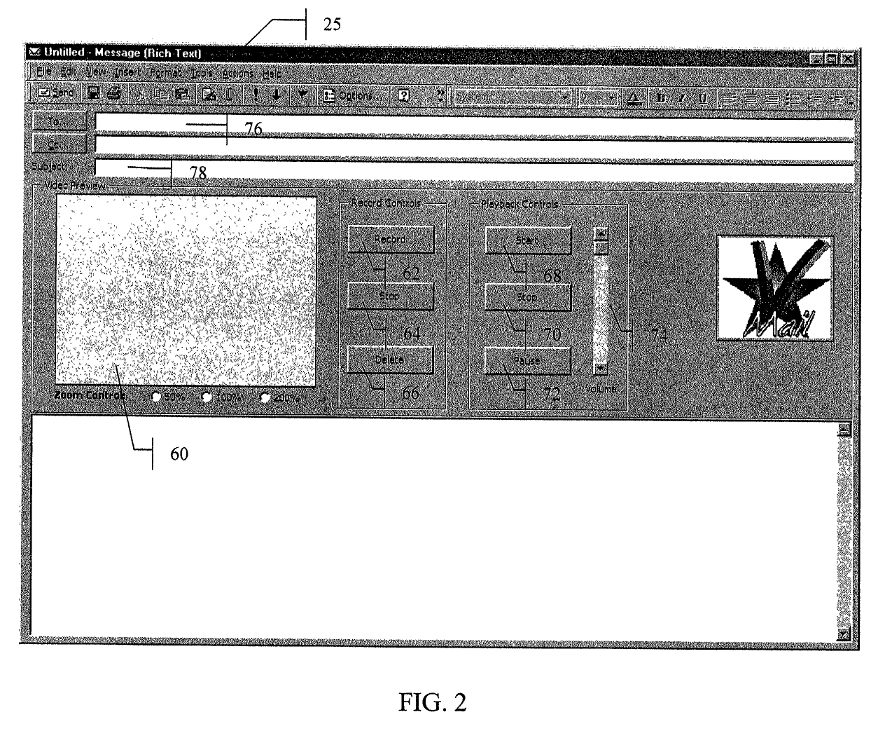

When the client application software to send video mail is activated at sender computer 20, a user interface window as exemplified in FIG. 2 is opened. The client application captures the resources required to create video electronic mail and once it has verified that there is connectivity to resources required on the computer, the client application allows the user to start recording a video file. The video file is displayed in a video window 60. Record controls on the user interface include record button 62, stop button 64 and delete button 66. Playback controls also provided on the user interface include start button 68, stop button 70, pause button 72 and a volume scroll bar 74. When the user has finished recording a video file, a stop function is activated which is available among the record controls on the electronic mail template. The user can then preview the recorded video by playing it back in video window 60. At the conclusion of video recording, the user types in a text message, and can also add or attach additional standard files as can be done with any standard electronic mail message. The client application works basically like electronic mail except that it has video capability as well. In the context of the present application, the term “video” is intended to also include any associated audio, so in reality, multimedia content is provided by the client software on the sender computer 20 to the video-streaming server 50.

When the user is satisfied with the content of the message, he then completes the addressees 76 and subject line 78. Addressees can range from a single addressee to many. The electronic mail message then proceeds through the normal electronic mail server provided by an ISP. Im mediately preceding the sending of the electronic mail, the client application identifies a file name for the video file. One file name format which can be used is the user name, the date and a timestamp, and possibly a random digital code, as for example, a four character hexadecimal code. The file name is a unique identifier for the video message. The complete path to the video file located on the video-streaming server 50 is created as an icon attachment to the electronic mail message that is transmitted via a standard server. The video portion is then transmitted across an Internet connection to the video-streaming server 50 where it is stored on the server. The same file name added by the client application software is retained at the video-streaming server 50.

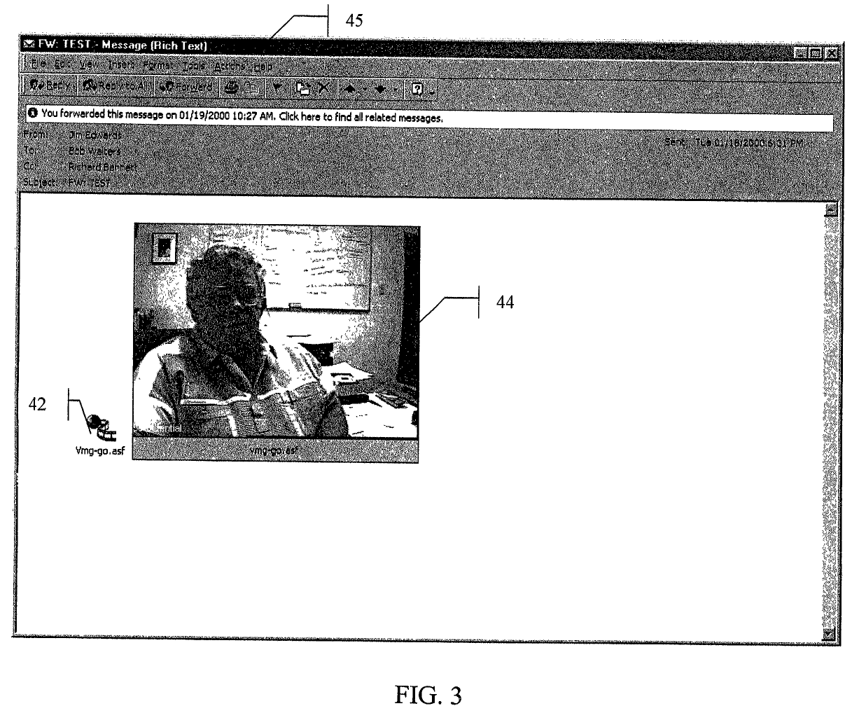

The receiver computer 40 receives a standard electronic mail message from the sender computer 20 via electronic mail services 30. The standard electronic mail message contains an icon attachment that is a link back to the video-streaming server 50 URL site. A typical user electronic mail interface at the receiver computer 40 is illustrated in FIG. 3. Shown in the figure is a video window 44 and an icon attachment 42. The recipient of an electronic mail message having a video icon attachment double clicks on the icon which basically is a call to the video file stored on video-streaming server 50. The video file is streamed off of video-streaming server 50 to the local workstation computer 40.

The video-streaming server 50 uses a store-and-forward concept. The video-streaming server 50 basically provides a storage vehicle for storing large multimedia files for electronic mail users. The sender computer 20 stores the video file on the video-streaming server 50 and it is forwarded to a receiver computer 40 on demand.

In addition to the database associated with the video-streaming server 50, there is an additional database server resident at the video-streaming server website that takes care of administrative matters associated with a subscription-based video mail process. This database server keeps track of how many mail messages the sender has sent, the length of the video mail messages, and the addresses. This administrative database server basically provides financial and information gathering processes associated with the video-streaming server 50.

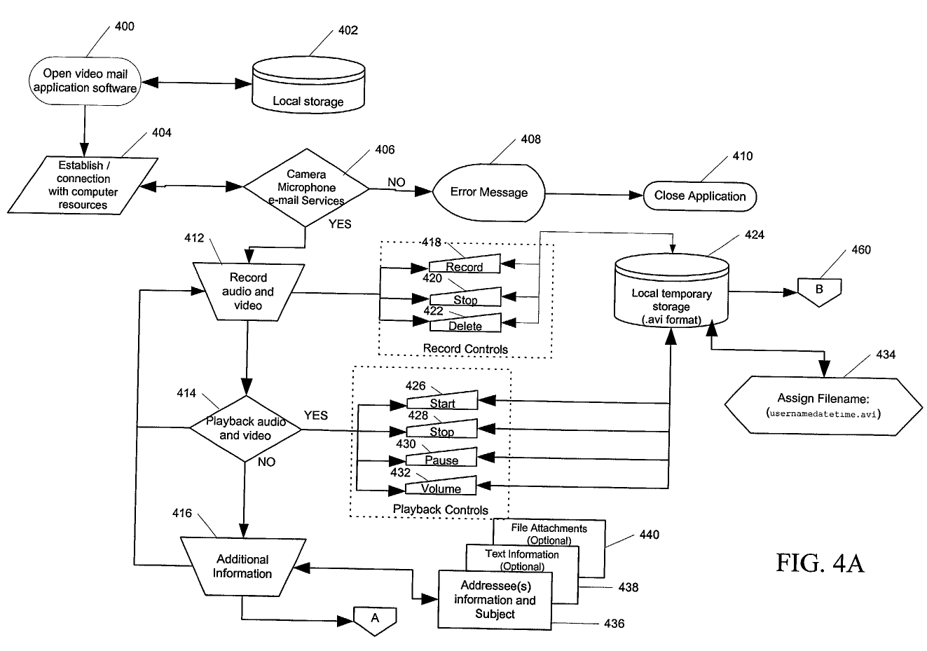

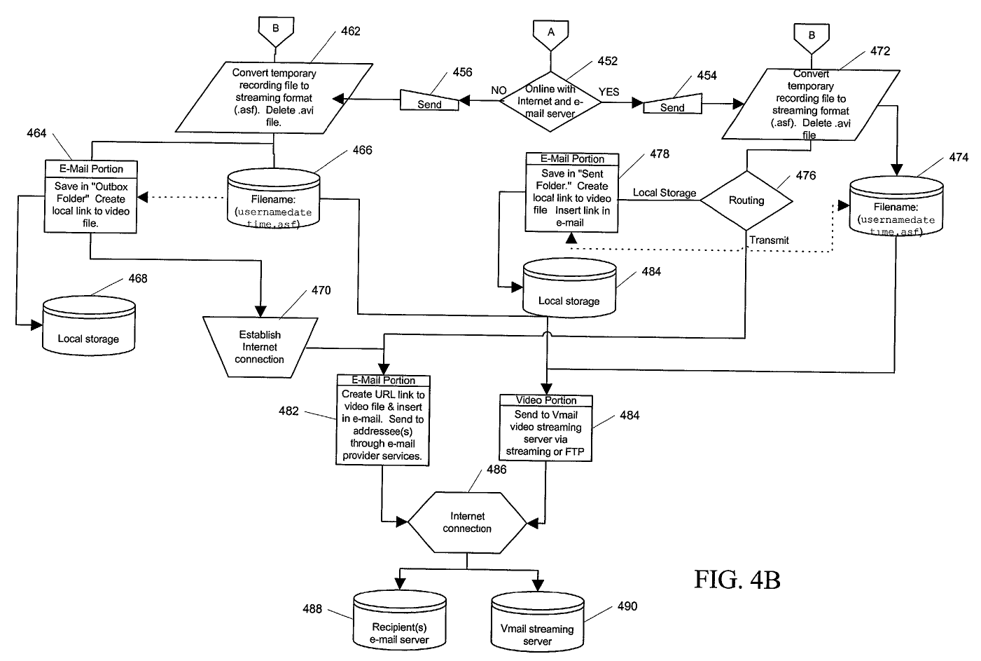

The processing logic associated with the video mail delivery system of the present invention is depicted in FIGS. 4A-4B. In logic block 400 the video mail application software is opened on the sender computer. The software is resident on local storage device 402. When the video mail application software is open, an attempt is to made to establish connections with computer resources as indicated in logic block 404. A test is made in decision block 406 to determine if a camera, microphone and electronic mail services are available on the sending computer. If those resources are not available, then in logic block 408 an error message is presented to the user and the application closes as indicated by termination block 410. If those resources are available, then the user is allowed to proceed and record audio and video content as indicated in logic block 412. Associated with the recording controls are record logic 418, stop logic 420 and delete logic 422. The recorded multimedia content is stored on local temporary storage 424 in an “.avi” format. The client application on the sender computer assigns a file name to the AVI file as indicated by logic block 434.

Following the recording of audio and video in logic block 412, the user can playback the audio and video as indicated in decision block 414. If the user selects playback, he then has playback controls including a start function 426, a stop function 428, a pause function 430 and a volume function 432. Like the record control, the playback functions also interface directly with local temporary storage 424.

Once the user is satisfied with the audio and video content of a video message, he then adds additional information as indicated in logic block 416. This can include addressee information and subject indicated by logic block 436, text information (optional) as indicated by logic block 438 and file attachments (optional) as indicated by logic block 440.

Processing then continues in decision block 452 with a determination of whether or not the sender computer 20 is on-line with an Internet and electronic mail server. If yes, then the send function 454 is activated and the temporary AVI recording file is converted to a streaming format (“.asf”). The “.avi” file is then automatically deleted from local temporary storage. The “.asf” file is stored in local storage 474 with a file name of the form “user_name_date_time.asf”. The operator at sender computer 20 is given an opportunity in decision block 476 to save the electronic mail message in a “sent” folder. A local link to the video file is then created and inserted into the electronic mail message as indicated in logic block 478. The sent folder is then stored in local storage 480. In decision block 476, a decision is made whether to route the electronic mail portion to the local storage 480 or to directly transmit the electronic mail portion and the video portion along separate paths. As indicated in logic block 484, the video portion is sent to the email video-streaming server 50 via streaming or File Transfer Protocol (FTP). The electronic mail portion is sent via an electronic mail message to the receiver computer 40 as indicated in logic block 482. In doing so, a URL link is created to the video file and inserted into the electronic mail message. The electronic mail message is sent to the addressee(s) through the electronic mail provider services. An Internet connection 486 is then established between the sender computer 20 and the receiver computer 40 to receive the electronic mail message via the recipient's electronic mail server 488, and a separate connection is established between the video-streaming server 50 and the sender computer 20 to store the video portion on the video mail streaming server 490.

If in decision block 452, a determination is made that the sender computer 20 is not on-line with the Internet and an electronic mail server, then in logic block 456 a send operation is performed that converts the temporary recording file to a streaming format (“.asf”) as indicated in logic block 462. The “.avi” file that was created is also deleted automatically. After the temporary recording file is converted to streaming format, it is saved as a file name of the form “user_name_date_time.asf” as indicated by storage device 466. At the same time, the electronic mail portion is saved in an “outbox” folder and a local link to the video file is created as indicated in logic block 464. The electronic mail portion is then stored in local storage 468. At a later time, when an Internet connection is established as indicated in logic block 470, the electronic mail portion is sent from the sender computer through the electronic mail provider services as indicated in logic block 482. Simultaneously, the locally saved video file is transmitted from storage 466 to the video-streaming server as indicated in logic block 484. The electronic mail portion and the video portion are then stored on the recipient's electronic mail server 488 and the video-streaming server 490, respectively.

The video mail delivery system of the present invention has been described as computer-implemented processes in the context of client application software resident on a client device and server application software resident on a video server with associated databases, and accessible over a public non-trusted network such as the Internet. It is important to note; however, that those skilled in the art will appreciate that the mechanisms of the present invention are capable of being distributed as program products in a variety of forms, and that the present invention applies regardless of the particular type of signal bearing media utilized to carry out the distribution. Examples of signal bearing media include, without limitation, recordable-type media such as diskettes or CD-ROMs, and transmission type media such as analog or digital communications links.

Additionally, the corresponding structures, materials, acts, and equivalents of any means plus function elements in any claims are intended to include any structure, material or acts for performing the function in combination with other claimed elements as specifically claimed.

While the invention has been particularly shown and described with reference to a preferred embodiment thereof, it will be understood by those skilled in the art that various other changes in form and detail may be made without departing from the spirit and the scope of the invention.

What is claimed is:

1. A method for delivery of video electronic mail from a sender client device to a receiver client device over a communications network, comprising the steps of:
generating a video file at the sender client device;
streaming the video file to a video server and storing the video file on the video server until the video file is accessed by the receiver client device;
sending an electronic mail notification of the video file to the receiver client device; and
streaming the video file from the video server storage in response to a request from the receiver client device.

2. The method for delivery of video electronic mail of claim 1 wherein the step of generating a video file comprises the acts of:
providing a video mail message window with controls for recording and playback of video and audio content;
recording video and audio content and storing the video and audio content in a standard format at the sender client device;
converting the video and audio content to a compressed streaming format video file; and
inserting a link to the compressed video file in the video mail message window.

3. The method for delivery of video electronic mail of claim 2 wherein the step of generating a video file further comprises the act of adding a text message to the video mail message window.

4. The method for delivery of video electronic mail of claim 1 wherein the step of streaming and storing the video file on the video server comprises the acts of:
transmitting the video file over the communications network to the video server;
receiving the video file from the sender client device;
verifying the integrity of the video file and testing the video file for virus contamination; and
storing the video file in a database at the video server.

5. The method for delivery of video electronic mail of claim 1 wherein the step of sending an electronic mail notification comprises the act of transmitting an electronic mail content of the video mail message with an inserted link to an associated video file to a mail server of a communications network service provider.

6. The method for delivery of video electronic mail of claim 1 wherein the step of streaming the video file from the video file storage comprises the acts of:
receiving a request for the video file from the receiver client device through a communications network service provider;
verifying that the receiver client device is capable of receiving the video file;
transmitting the video file to the receiver client device through the communications network service provider; and
displaying the video file in a video message display window at the receiver client device.

7. The method for delivery of video electronic mail of claim 6 wherein the act of transmitting the video file to the receiver client device comprises the acts of sending the video file in packets over the communications network to a buffer in the receiver client device.

8. The method for delivery of video electronic mail of claim 6 wherein the act of displaying the video file comprises the acts of:
launching a video player at the receiver client device; and
sending the contents of the buffer continuously to the video player.

9. The method for delivery of video electronic mail of claim 2 wherein the compressed streaming file format is Advanced Streaming Format (ASF).

10. The method for delivery of video electronic mail of claim 2 wherein the standard format is Audio Video Interleave (AVI) format.

11. The method for delivery of video electronic mail of claim 2 wherein the step of inserting a link comprises adding a video icon representing the video file in the video mail message window.

12. The method for delivery of video electronic mail of claim 1 wherein the video file is deleted from the video server storage after a predetermined period of time.

13. A computer readable medium containing a computer program product operable on a sender client device for delivery of video electronic mail to a receiver client device over a communications network, the computer program product comprising:
program instructions that generate a video file at the sender client device;
program instructions that stream the video file to a video server for storage until the video file is accessed by the receiver client device; and
program instructions that send an electronic mail notification of the video file to the receiver client device.

14. The computer program product for delivery of video electronic mail of claim 13 wherein the program instructions that generate a video file comprise:
program instructions that provide a video mail message window with controls for recording and playback of video and audio content;
program instructions that enable recording of video and audio content and storing of the video and audio content in a standard format;
program instructions that convert the video and audio content to a compressed streaming format video file; and
program instructions that insert a link to the compressed video file in the video mail message window.

15. The computer program product for delivery of video electronic mail of claim 14 wherein the program instructions that generate a video file further comprise program instructions that enable an addition of a text message to the video mail message window.

16. The computer program product for delivery of video electronic mail of claim 1 wherein the program instructions that stream the video file for storage on the video server comprise program instructions that enable transmission of the video file over the communications network to the video server.

17. The computer program product for delivery of video electronic mail of claim 13 wherein the program instructions that send an electronic mail notification comprise program instructions that enable transmission of an electronic mail content of the video mail message with an inserted link to an associated video file to a mail server of a communications network service provider.

18. The computer program product for delivery of video electronic mail of claim 14 wherein the compressed streaming file format is Advanced Streaming Format (ASF).

19. The computer program product for delivery of video electronic mail of claim 14 wherein the standard format is Audio Video Interleave (AVI) format.

20. The computer program product for delivery of video electronic mail of claim 14 wherein the program instructions for inserting a link comprise program instructions that add a video icon representing the video file in the video mail message window.

21. A computer readable medium containing a computer program product operable on a video server for delivery of video electronic mail to a receiver client device over a communications network, the computer program product comprising:
program instructions that enable receiving of the video file from the sender client device;
program instructions that verify the integrity of the video file and test the video file for virus contamination; and
program instructions that store the video file in a database at the video server; and
program instructions that stream the video file from the video server database in response to a request from the receiver client device.

22. The computer program product for delivery of video electronic mail of claim 21 wherein the program instructions that streaming the video file comprise:
program instructions that receive a request for the video file from the receiver client device through a communications network service provider;
program instructions that verify the receiver client device is capable of receiving the video file;
program instructions that enable transmission of the video file to the receiver client device through the communications network service provider.

23. The computer program product for delivery of video electronic mail of claim 22 wherein the program instructions that enable transmission of the video file to the receiver client device comprise program instructions that send the video file in packets over the communications network to a buffer in the receiver client device.

24. The computer program product for delivery of video electronic mail of claim 21 further comprising program instructions that delete the video file from the video server storage after a predetermined period of time.

25. A video mail server system for the delivery of video electronic mail to at least one receiver client device over a communications network, comprising:
a database for storing a plurality of video mail files for access by an intended receiver client device;
a store and forward server for receiving the plurality of video mail files from a plurality of sender client devices and storing the plurality of video mail files in the database; and
a video mail application program operable on the store and forward server to handle requests for specific video mail delivery from the at least one receiver client device.

26. The video mail server system for the delivery of video electronic mail of claim 25 wherein the video mail application program further comprises:
a first verification component for verifying the integrity of each video mail file received from a sender client device;
a second verification component for determining that the intended receiver client device is capable of receiving the specific video mail; and
a transmission component for sending the specific video mail to the intended receiver client device over the communications network.

27. A client device for the sending of video electronic mail to at least one receiver client device via a video server over a communications network, comprising:
a processor for controlling the generation of video mail messages;
a video camera and audio microphones connected to the processor for recording of a specific audio and video mail message in a standard format;
compression software operable on the processor for reformatting and compression of the audio and video mail message in a video mail file;
a local storage device for temporary storage of the specific video mail; and
a video mail user interface window for providing controls for recording and playback of video and audio content in the video mail message.

28. The client device for the sending of video electronic mail of claim 27 further comprising a video mail application program operable on the processor for inserting a video mail message link on the video mail user interface window, for adding a text message to the video mail message, and for transmitting the video content of the video mail message to the video server.

29. The sender client device for the sending of video electronic mail of claim 28 wherein the video mail application program transmits the electronic mail content of the video mail message, and the video mail message link to a mail server of a communications network services provider for delivery to the at least one receiver client device.
